(19) United States
(12) Patent Application Publication
(10) Pub. No.: US 2026/0223258 A1
(43) Pub. Date: Jul. 30, 2026

(54) INDUCTION MAGNETIC FIELD CARRIER INTEGRATED APPARATUS AND METHOD FOR CHANGING PHYSICOCHEMICAL CHARACTERISTICS OF LIQUID SAMPLE

(71) Applicant: BIOMAG INNOVATIONS LLC, SEBASTIAN, FL (US)

(72) Inventors: Na YANG, SEBASTIAN, FL (US); Yamei JIN, SEBASTIAN, FL (US); Yuyi ZHOU, SEBASTIAN, FL (US); Xueming XU, SEBASTIAN, FL (US); Shasha HUANG, SEBASTIAN, FL (US); Rongming LI, SEBASTIAN, FL (US); Lingtao ZHANG, SEBASTIAN, FL (US)

(73) Assignee: BIOMAG INNOVATIONS LLC, SEBASTIAN, FL (US)

(21) Appl. No.: 19/561,589

(22) Filed: Mar. 10, 2026

(30) Foreign Application Priority Data
Dec. 25, 2025 (CN) 202511982119.8

(51) Int. Cl. H05B 6/36; H01F 27/24; H01F 27/28

(52) U.S. Cl. CPC H05B 6/36; H01F 27/24; H01F 27/28

(57) ABSTRACT

Provided are an induction magnetic field carrier integrated apparatus and a method for changing physicochemical characteristics of a liquid sample. The induction magnetic field carrier integrated apparatus includes: a magnetic coupling integrated component, which includes N magnetic core inductive coils, the N magnetic core inductive coils are combined into one or more magnetic core inductive coil sets, M magnetic core inductive coils of the magnetic core inductive coil set are sequentially arranged along a selected trajectory, and windows of the M magnetic core inductive coils of the magnetic core inductive coil set are connected in sequence to form a hollow structure. A part of a sample tube is disposed in the hollow structure of the magnetic coupling integrated component, and an intermediate-frequency induction magnetic flux can induce production of an induced electric/magnetic field in or around a liquid sample in the sample tube, where N>=M>=2.

### CROSS REFERENCE TO THE RELATED APPLICATIONS

This application is based upon and claims priority to Chinese Patent Application No. 202511982119.8, filed on Dec. 25, 2025, the entire contents of which are incorporated herein by reference.

### TECHNICAL FIELD

The present disclosure relates in particular to an induction magnetic field carrier integrated apparatus for inducing a liquid sample to produce an induced electric/magnetic field and a method for changing physicochemical characteristics of a liquid sample, belonging to the field of engineering thermal technologies.

### BACKGROUND

Most existing induced electric/magnetic field generators employ a conventional single magnetic circuit structure. When such apparatuses operate under intermediate-frequency excitation, to enable the inductive self-heating of the liquid sample, magnetic circuits typically operate at a relatively high frequency and a relatively high operating magnetic density which is close to a magnetic saturation state of the magnetic circuit. In this case, a significant eddy current loss and iron loss are prone to occur inside a magnetic core, leading to additional energy loss and resulting in extremely low energy efficiency of the apparatus. In addition, in a conventional apparatus (for example, a magnetic circuit structure disclosed in US20250244290A1), single magnetic core or distributed magnetic cores are generally disposed and combined. Therefore, a relatively large non-uniform magnetic field distribution exists in a surrounding space, and magnetic leakage increases during energy coupling, which further increases energy loss. Due to the loss, severe thermal effect occurs when the magnetic core operates in a saturated magnetic flux state. Existing cooling methods have limited efficiency and are prone to causing overload operation, which not only leads to poor performance and reduced conversion efficiency of the magnetic circuit, but also shortens the service life of a magnetic material, making the parts or components unfit for large-scale application.

Therefore, how to ensure effective output of intermediate-frequency magnetic field energy in the liquid sample, enable the sample to produce an induction electric/magnetic field to achieve rapid heating effect, and reduce magnetic loss and eddy current heating loss has become an urgent technical challenge in this field. Therefore, there is an urgent need to create a novel magnetic energy conversion structure for direct heating of liquid sample.

### SUMMARY

A main objective of the present disclosure is to provide an induction magnetic field carrier integrated apparatus and a method for changing physicochemical characteristics of a liquid sample, thereby overcoming disadvantages in the prior art.

To implement the foregoing objective, the technical solution employed by the present disclosure as follows.

A first aspect of an embodiment of the present disclosure provides an induction magnetic field carrier integrated apparatus for inducing a liquid sample to produce an induced electric/magnetic field, including:
a magnetic coupling integrated component, including N magnetic core inductive coils, where the N magnetic core inductive coils are combined into one or more magnetic core inductive coil sets, M magnetic core inductive coils of the magnetic core inductive coil set are disposed in sequence along a selected trajectory, windows of the M magnetic core inductive coils of the magnetic core inductive coil set are connected in sequence to form a hollow structure, the magnetic core inductive coil includes a magnetic core and a winding wound around the magnetic core, the winding is electrically connected to a power supply, and the winding is configured to enable the magnetic core inductive coil to convert a current provided by the power supply into an intermediate-frequency induction magnetic flux; and
at least one sample tube, where at least a part of the sample tube is disposed in the hollow structure of the magnetic coupling integrated component and passes through windows of the M magnetic core inductive coils, the sample tube is used to hold a liquid sample and allow continuous flow of the liquid sample, and the intermediate-frequency induction magnetic flux is capable of inducing production of an induced electric/magnetic field in the liquid sample in the sample tube, N>=M>=2.

A second aspect of the embodiment of the present disclosure provides a method for changing physicochemical characteristics of a liquid sample, including:
providing the induction magnetic field carrier integrated apparatus for inducing a liquid sample to produce an induced electric/magnetic field; and
loading the liquid sample into a sample tube, and connecting windings of N magnetic core inductive coils to a power supply to form an intermediate-frequency induction magnetic flux in each magnetic core inductive coil, where the intermediate-frequency induction magnetic flux induces production of an induced electric/magnetic field in the liquid sample in the sample tube.

Compared with the prior art, the advantages of the present disclosures are as follows. Through an induction magnetic field carrier integrated apparatus for inducing a liquid sample to produce an induced electric/magnetic field provided in this embodiment of the present disclosure, a brand new magnetoelectric coupling treatment approach of the liquid sample is accidentally obtained by performing continuous design on a magnetic circuit configuration trajectory of a novel magnetic coupling integrated component. That is, an induced magnetic field and an induced electric field of the liquid sample can be simultaneously produced, and the operating points of magnetic flux density in the magnetic circuit or magnetic core are significantly reduced, so that energy utilization and operation stability are improved when a proper magnetic flux density is ensured, and a treatment or a processing requirement based on the induced electric/magnetic field of the liquid sample under intermediate-frequency and high power conditions is satisfied.

### BRIEF DESCRIPTION OF THE DRAWINGS

FIG. 1 is an operation diagram of an entire system of an induction magnetic field carrier integrated apparatus for inducing a liquid sample to produce an induced electric/magnetic field according to a typical embodiment of the present disclosure;

FIG. 2 is a diagram of a structure of a magnetic coupling integrated component of a circular structure according to a typical embodiment of the present disclosure;

FIG. 3 is a diagram of a structure of a magnetic coupling integrated component of a rectangular looped-shaped structure according to a typical embodiment 2 of the present disclosure;

FIG. 4 is a diagram of a magnetic core structural dimension of a rectangular magnetic core inductive coil and a layout of a sample tube in a window region of a magnetic core inductive coil according to Embodiment 1 of the present disclosure;

FIG. 5 is a diagram showing arrangement of a sample tube with one branch as well as two electrical parameter measurement points according to Embodiment 1 of the present disclosure;

FIG. 6 is a diagram of a unit structure of an induction magnetic field carrier apparatus according to Comparative Example 1, which is different from that in Embodiment 1;

FIG. 7 is a diagram of eighteen independent and parallel-connected unit structures of an induction magnetic field carrier apparatus according to Comparative Example 1, which is different from that in Embodiment 1;

FIG. 8 is a diagram showing an electrical parameter measurement point according to Comparative Example 1;

FIG. 9 is a diagram of a perspective structure of a magnetic coupling integrated component according to Embodiment 2;

FIG. 10 is a diagram of a magnetic core structural dimension of a circular magnetic core inductive coil and a layout of a sample tube in a window region of a magnetic core inductive coil according to Embodiment 2;

FIG. 11 is a diagram showing a layout of a sample tube with one branch as well as two electrical parameter measurement points according to Embodiment 2 of the present disclosure;

FIG. 12 is a diagram of eighty independent and parallel-connected unit structures of an induction magnetic field carrier apparatus according to Comparative Example 2, which is different from that in Embodiment 2.

### DETAILED DESCRIPTION OF THE EMBODIMENTS

In view of deficiencies in the prior art, the inventors of this case have been able to propose the technical solutions of the present disclosure through long-term research and numerous practices. The technical solution, implementations and principle of the present disclosure are further explained and described below.

Most existing induced electric/magnetic field generators employ a conventional single magnetic circuit structure, that is, a single magnetic core is employed, where the sample tube is spirally wound around the exterior of the single magnetic core, a magnetic induction line of the magnetic core passes vertically through the spiral sample tube to process the liquid sample inside the tube. According to the induction magnetic field carrier integrated apparatus for inducing a liquid sample to produce an induced electric/magnetic field provided by an embodiment of the present disclosure, research on specific magnetic circuit configuration trajectories has unexpectedly revealed that when multiple magnetic cores are integrated into a loop-shaped or multi-columnar hollow structure and a closed electric/magnetic circuit is formed, a special magnetoelectric coupling effect is produced in the sample tube with a closed loop structure. In addition, such a brand new magnetic circuit integration mode can further overcome problems of high magnetic loss and eddy current loss and insufficient energy conversion efficiency in the prior art. In the present disclosure, the development of the magnetic coupling integrated component enhances its performance and significantly reduces operating magnetic flux density points, thereby ensuring efficient magnetic energy output under intermediate-frequency condition and improving energy conversion efficiency and operational stability. The requirements for the simultaneous production of induced electric/magnetic fields and heating treatment of a liquid sample under a high-power condition are satisfied.

A first aspect of an embodiment of the present disclosure provides an induction magnetic field carrier integrated apparatus for inducing a liquid sample to produce an induced electric/magnetic field, including:
a magnetic coupling integrated component, including N magnetic core inductive coils, where the N magnetic core inductive coils are assembled into one or more magnetic core inductive coil sets, M magnetic core inductive coils of the magnetic core inductive coil set are arranged in sequence along a selected trajectory, windows of the M magnetic core inductive coils of the magnetic core inductive coil set are connected in sequence to form a hollow structure, the magnetic core inductive coil includes a magnetic core and a winding wound around the magnetic core, the winding is electrically connected to a power supply, and the winding is configured to enable the magnetic core inductive coil to convert a current provided by the power supply into an intermediate-frequency induction magnetic flux; and
at least one sample tube, where at least a part of the sample tube is disposed in the hollow structure of the magnetic coupling integrated component and passes through windows of the M magnetic core inductive coils, the sample tube is used to hold a liquid sample and allow continuous flow of the liquid sample, and the intermediate-frequency induction magnetic flux is capable of inducing production of an induced electric/magnetic field in the liquid sample in the sample tube, N>=M>=2.

Further, structure configurations of the N magnetic core inductive coils are or different, and intermediate-frequency induction magnetic fluxes formed by the N magnetic core inductive coils are identical or different.

Further, the intermediate-frequency induction magnetic flux formed by a single magnetic core inductive coil has an operating magnetic flux density of 0.2 T-1.0 T and a magnetic field frequency of 5 kHz-100 kHz.

Further, the intermediate-frequency induction magnetic flux is a magnetic field that varies over time, and includes, but is not limited to, an alternating magnetic field or a pulsed magnetic field. A waveform of an excitation voltage of the intermediate-frequency induction magnetic flux may be one, or a combination of more than two, of a sawtooth wave, a spike wave, a square wave, a pulse wave, or a sine wave.

Further, an alternating current (sine wave) produces a periodically varying magnetic field, and the induction magnetic flux varies continuously in a sinusoidal manner, with stable operation power and capability of continuous energy input. However, the magnetic field correspondingly produced by the pulse or square wave is a transient mutation, and magnetoelectric coupling energy is also input in a transient form. In addition, for an intermediate-frequency induction magnetic flux, a higher frequency within a same bandwidth means a stronger magneto-electric coupling field. In particular, intermediate-frequency pulses can generate molecular polarization, electroporation, micro-local breakdown, non-thermal effects, and the like inside the liquid sample. That is to say, application of the alternating current is equivalent to Joule heating (ohmic heating), while pulsed electricity has both heating and electric surge effects.

For example, a material of the magnetic core is selected from one or more of Fe-based amorphous alloy, Fe-based nanocrystalline alloy, amorphous-nanocrystalline alloy, or permalloy.

Further, an effective cross-sectional area of a magnetic circuit of a single magnetic core inductive coil in the magnetic coupling integrated component is 0.8 cm²-200 cm².

In a relatively typical implementation, the selected trajectory is a closed geometric trajectory, a window plane of the magnetic core inductive coil is in a non-parallel state with a plane enclosed by the geometric trajectory, and the magnetic core inductive coil set has a loop-shaped structure. For example, the window plane of the magnetic core inductive coil intersects the plane enclosed by the geometric trajectory.

Further, the geometric trajectory is a planar geometric trajectory, and the planar geometric trajectory is a regular geometric trajectory or an irregular geometric trajectory.

Further, the regular geometric trajectory includes a circular trajectory or a polygonal trajectory. For example, the polygonal trajectory may be a rectangular trajectory, a diamond-shaped trajectory, a triangular trajectory, or other two-dimensional geometric trajectories, and the irregular geometric trajectory may be an irregular quadrilateral trajectory or another polygonal trajectory.

Further, the selected trajectory is the circular trajectory, the loop-shaped structure is a circular structure, the M magnetic core inductive coils are radially arranged with the geometric center of the circular trajectory as the center, and the window plane of the magnetic core inductive coil intersects with a plane enclosed by the circular trajectory.

Alternatively, the selected trajectory is a rectangular trajectory, the loop-shaped structure is a rectangular loop-shaped structure, the M magnetic core inductive coils are disposed in sequence in a long-side direction and/or a wide-side direction of the rectangular trajectory, and the window plane of the magnetic core inductive coil intersects with a plane enclosed by the rectangular trajectory.

Alternatively, the selected trajectory is a rectangular trajectory, the loop-shaped structure is a rectangular loop-shaped structure, the M magnetic core inductive coils are radially arranged with the geometric center of the rectangular trajectory as the center, and the window plane of the magnetic core inductive coil intersects with a plane enclosed by the rectangular trajectory.

In another relatively typical implementation, the selected trajectory is a linear trajectory, the window plane of the magnetic core inductive coil is parallel to a radial cross section of the hollow structure, and the magnetic core inductive coil set has a columnar structure.

Further, the selected trajectory is a straight line trajectory, and a central axis of the hollow structure is parallel to the straight line trajectory. It may be understood that, in this scheme, a radial cross-sectional profile of the columnar structure and the hollow structure therein is consistent with a profile shape of the window of the single magnetic core inductive coil.

Further, the sample tube passes through windows of hollow regions of M magnetic cores in the magnetic core inductive coil set.

Further, a portion of the sample tube located inside the hollow structure is of a columnar structure, a loop-shaped structure, or a spiral structure, a profile shape of an orthographic projection (the projection formed along its own axial direction) of the loop-shaped structure/spiral structure of the sample tube may be identical to or different from that of the hollow structure.

Further, the portion of the sample tube located inside the hollow structure includes one or more annular tube segments, and the multiple annular tube segments are formed by winding the sample tube in a planar-spiral or axial-spiral configuration.

Further, the multiple annular tube segments are sequentially disposed in an axial direction of the loop-shaped structure/spiral structure formed by the multiple annular tube segments, or are sequentially nested in a radial direction of the loop-shaped structure/spiral structure formed by the multiple annular tube segments.

Further, a portion of the sample tube located inside the hollow structure of the magnetic coupling integrated component includes one or more cylindrical tube segments, and the multiple cylindrical tube segments are formed by disposing the sample tube in parallel.

Further, the sample tube includes one or more branch structures, and the branch structure forms a closed loop.

Further, the sample tube is disposed in one sleeve, and the sleeve is disposed in the hollow structure.

In a relatively specific implementation, the induction magnetic field carrier integrated apparatus for inducing a liquid sample to produce an induced electric/magnetic field further includes a cooling module, where the cooling module is used to adjust an operating temperature of the magnetic coupling integrated component.

A second aspect of the embodiment of the present disclosure provides a method for changing physicochemical characteristics of a liquid sample, including the following steps. The induction magnetic field carrier integrated apparatus for inducing a liquid sample to produce an induced electric/magnetic field is provided.

The liquid sample is loaded into a sample tube, and windings of N magnetic core inductive coils are connected to a power supply to form an intermediate-frequency induction magnetic flux in each magnetic core inductive coil, where the intermediate-frequency induction magnetic flux induces production of an induced electric/magnetic field in the liquid sample in the sample tube.

Further, the intermediate-frequency induction magnetic flux produced by a single magnetic core inductive coil has an operating magnetic flux density of 0.2 T-1.0 T and a magnetic field frequency of 5 kHz-100 kHz; and then an induced electric field loaded in the liquid sample has an electric field intensity of 0.1 V/cm-300 V/cm, and an induced magnetic field of the liquid sample has a magnetic field intensity of 1 μT-200 μT.

Further, the intermediate-frequency induction magnetic flux is a magnetic field that varies over time, and includes, but is not limited to, an alternating magnetic field or a pulsed magnetic field. A waveform of an excitation voltage of the intermediate-frequency induction magnetic flux may be one, or a combination of more than two, of a sawtooth wave, a spike wave, a square wave, a pulse wave, or a sine wave.

The liquid sample has an electrical conductivity of 0.01 S/m-18.0 S/m.

Further, the method for changing physicochemical characteristics of a liquid sample includes that the liquid sample is kept in a stationary or flowing state in the sample tube.

Further, the method for changing physicochemical characteristics of a liquid sample includes: keeping an operating temperature of the magnetic coupling integrated component at 30° C.-130° C.

The technical solution, implementations and principle of the present disclosure are further explained and described below with reference to accompanying drawings and specific embodiments.

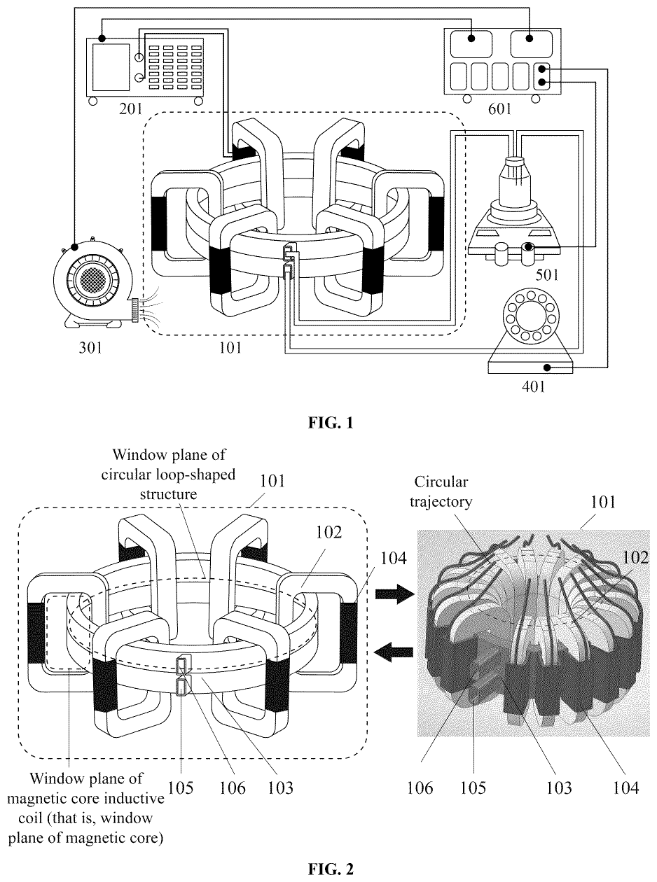

In a relatively specific implementation, with reference to FIG. 1, an induction magnetic field carrier integrated apparatus for inducing a liquid sample to produce an induced electric/magnetic field includes a magnetic coupling integrated component 101 and a sample tube 103, where the magnetic coupling integrated component 101 is electrically connected to an excitation power supply 201, a current provided by the excitation power supply 201 is converted into an intermediate-frequency induction magnetic flux, and a closed loop of magnetic circuit is formed, namely, a closed magnetic field. The sample tube 103 is used to hold the liquid sample, the liquid sample includes an electrolyte solution or a multiphase complex electrolyte sample. At least a part of the sample tube 103 is disposed in the magnetic coupling integrated component 101 and is disposed inside the loop of magnetic circuit. An intermediate-frequency induction magnetic flux provided by the magnetic coupling integrated component 101 can induce production of an induced electric/magnetic field in the liquid sample placed in the sample tube 103.

Specifically, with reference to FIG. 2, the magnetic coupling integrated component 101 includes N magnetic core inductive coils, the N magnetic core inductive coils are assembled into one or more magnetic core inductive coil sets, M magnetic core inductive coils of the magnetic core inductive coil set are disposed in a loop-shaped region along a circular trajectory (that is, a selected trajectory is a circular trajectory, and a structure shown in FIG. 2 is that a window plane of the magnetic core inductive coil is in a perpendicular cross state with a plane enclosed by the geometric trajectory) in a spaced manner. Windows of the M magnetic core inductive coils of the magnetic core inductive coil set are connected in sequence to form a hollow structure, where the magnetic core inductive coil includes a magnetic core 102 and winding 104 wound around the magnetic core, the winding 104 is electrically connected to the excitation power supply 201, and the winding 104 is configured to enable the magnetic core inductive coil to convert electric energy of the excitation power supply 201 into magnetic energy inside an induction magnetic field carrier, thereby generating an intermediate-frequency induction magnetic flux. Each magnetic core inductive coil set has a loop-shaped structure, and a direction of a magneto-electric coupling field inside the hollow structure of each magnetic core inductive coil set is consistent with a circumferential direction of a loop-shaped region/circular trajectory. At least a part of the sample tube 103 passes through windows of the M magnetic cores 102. The sample tube 103 is used to hold an electrolyte sample and allow continuous flow of the liquid sample. The intermediate-frequency induction magnetic flux can induce the liquid sample in the sample tube 103 to produce an induced electric/magnetic field, N>=M>=2.

The circular trajectory is consistent with a profile shape of the loop-shaped region, and the circular trajectory may also be replaced with another geometric trajectory. Another geometric trajectory may be a planar geometric trajectory. The planar geometric trajectory may be a regular geometric trajectory or an irregular geometric trajectory. A shape of the regular geometric trajectory may be a rectangle, and other polygons. Examples for the shape of the irregular geometric trajectories are not provided.

Specifically, the winding 104 and the like are configured to convert the electric energy that is provided by the excitation power supply 201 and that has an output voltage frequency of 5 kHz-100 kHz into an intermediate-frequency induction magnetic flux with an operating magnetic flux density of 0.2 T-1.0 T at a frequency of 5 kHz-100 kHz in the magnetic core inductive coil. Specifically, a segment angle, quantity and magnetic circuit cross-sectional area of the magnetic core inductive coil are adjustable, thereby enabling the adjustment of output power and intensity of the intermediate-frequency induction magnetic flux. For example, when the cross-sectional area of an effective magnetic circuit in a whole magnetic coupling integrated component 101 increases or decreases, maximum output power of the magnetic coupling integrated component 101 increases or decreases correspondingly, and then a higher or lower induced electric/magnetic field can be produced in the liquid sample of the sample tube. Specifically, the effective cross-sectional area of the magnetic circuit of the single magnetic core inductive coil in the magnetic coupling integrated component 101 may be 0.8 cm²-200 cm².

Specifically, structural configurations of all magnetic core inductive coils are identical. When a same excitation power supply is connected thereto, intermediate-frequency induction magnetic fluxes formed by all the magnetic core inductive coils are the same. That is, all the magnetic cores are identical in terms of material, structure, and the like; and all windings are identical in terms of material, structural parameters, and the like. For example, all windings are identical in terms of the number of turns, wire diameter and winding method. Only in this way can electrical parameters (inductance, inductive reactance, impedance, and the like) of each magnetic core inductive coil be consistent, thereby maximizing the magnetic energy conversion or induction effect. Parameters (such as operating magnetic flux density, frequency, and waveform) of the intermediate-frequency induction magnetic fluxes formed by all the magnetic core inductive coils are consistent.

It may be understood that the intermediate-frequency induction magnetic flux formed by the single magnetic core inductive coil has an operating magnetic flux density of 0.2 T-1.0 T and a magnetic field frequency of 5 kHz-100 kHz. Specifically, a response speed and an energy transfer manner of electromagnetic induction are determined by the magnetic flux density, an arrangement manner and a configuration structure of the magnetic coupling integrated component, as well as a magnetic field frequency of the intermediate-frequency induction magnetic flux. A waveform signal of the intermediate-frequency induction magnetic flux may generate an optimal induced electromagnetic effect in a target liquid sample. If an arrangement manner and a configuration structure of the magnetic coupling integrated component do not meet special requirements of the present disclosure, the operating magnetic flux density and the magnetic field frequency of the intermediate-frequency induction magnetic flux may exceed a specific range, resulting in reduced electromagnetic coupling efficiency, generation of a non-target harmonic or loss of control effect, or failure to achieve expected conversion efficiency, power output, or a process effect.

Specifically, the windings in the magnetic core inductive coil may be disposed independently or in parallel. The independent windings offer stronger adjustability, while parallel windings enable easier synchronous control and higher magnetoelectric conversion efficiency. Specific arrangement manner can be selected according to actual requirements.

More specifically, the magnetic core 102 may be composed of multiple laminated or annular tape-wound soft magnetic materials, where the soft magnetic material may be at least one selected from Fe-based amorphous alloy, Fe—Ni-based amorphous alloy, Co-based amorphous alloy, Fe-based nanocrystalline alloy, cold-rolled silicon steel, permalloy, ferrite, ferritic stainless steel, and the like. Specifically, the winding 104 is formed by winding multiple strands of high-frequency wire or Litz wire in parallel around the magnetic core 102. The high-frequency wire or Litz wire may be a metal conductor. For example, the metal conductor may be a copper conductor, a silver conductor, an aluminum conductor, an enameled wire, or the like. Specifically, an outer surface of the magnetic core 102 may be provided with a winding slot, and the winding 104 is disposed in the winding slot.

In a typical implementation, as a whole, the magnetic core inductive coil may present a loop-shaped structure identical to that of the magnetic core 102, for example, a circular structure, a rectangular loop-shaped structure, or a polygonal loop-shaped structure. The window of the magnetic core inductive coil may be considered as a window of the magnetic core 102. For example, the M magnetic core inductive coils may be arranged in combination to form an annular hollow structure with a symmetrical shape (preferably a rotational symmetrical shape) similar to a Tokamak device, and the magnetic cores 102 may be connected by using fasteners known in the art.

With reference to FIG. 1 and FIG. 2 again, in a typical implementation, the M magnetic core inductive coils are sequentially arranged along a circular trajectory, and the magnetic core inductive coil set of the magnetic coupling integrated component has an internal hollow circular structure. Specifically, the M magnetic core inductive coils are radially arranged with the geometric center of the circular trajectory as the center, a window plane of the M magnetic core inductive coils is perpendicular to a window plane of the circular structure generally presented by the magnetic core inductive coil set as a whole, and a spacing (that is, a spacing between two adjacent magnetic core inductive coils) between the M magnetic core inductive coils gradually increases in a direction away from the geometric center of the circular trajectory. Such a structural configuration can improve the uniformity of magnetoelectric coupling effect in the hollow region of the magnetic coupling integrated component (the radial distribution with gradually increasing spacing ensures a more uniform magneto-electric effect generated by each magnetic core inductive coil in the window region), enhance the efficiency of the induced electric/magnetic field loaded in the sample, reduce an interference loss (an appropriate design of the spacing between the magnetic circuits can avoid mutual interference between the magnetic core inductive coils, reduce eddy current and loss, and improve the overall efficiency of the apparatus), and provide strong applicability (it can cover liquid samples in sample tubes with different volumes and shapes, thereby featuring excellent applicability), as well as facilitate the series connection and expansion of the apparatus.

With reference to FIG. 3, in another typical implementation, the M magnetic core inductive coils are sequentially arranged and distributed along a rectangular trajectory (that is, the selected trajectory is a rectangular trajectory). More specifically, the M magnetic core inductive coils may be arranged and distributed only along four straight line sides of the rectangular trajectory, the M magnetic core inductive coils may be arranged and distributed only along two long or short sides of the rectangular trajectory, or the M magnetic core inductive coils are arranged and distributed sequentially along a whole of the rectangular trajectory (in addition to the straight line sides, the magnetic core inductive coils are also correspondingly distributed at corners of the rectangular trajectory), that is, the magnetic coupling integrated component is configured as a rectangular loop-shaped structure or two parallel linear structures as a whole. The window plane of the magnetic core inductive coil is perpendicular to a window plane of the rectangular loop-shaped structure that is presented by the magnetic core inductive coil set as a whole, and a spacing between two adjacent magnetic core inductive coils arranged along a same straight line side of the rectangular trajectory remains the same, and the two adjacent magnetic core inductive coils are preferably disposed in parallel. Compared with a magnetic core inductive coil set of a circular structure, the rectangular loop-shaped structure is convenient for linear arrangement and modular assembly of the magnetic core inductive coils, and the magnetic core inductive coils can be artistically and flexibly disposed according to a linear flow path of the liquid sample.

Magnetic flux distribution in a straight line-side segment of the rectangular loop-shaped structure is relatively uniform and centralized, and the magnetoelectric effect of a local annular magnetic field in a corner region is conducive to enhancing the magnetoelectric induction intensity at an end position of a flow path of the liquid sample, thereby implementing intensity adaptation to the magnetic energy loaded on sample chambers of different shapes. For example, a ratio of a long-side length to a short-side length of the rectangular loop-shaped structure is 1.2:1-20:1.

Specifically, the sample tube 103 is a single-layer tube, a multi-layer parallel tube, or a spiral coiled tube that is fully or partially electrically insulated. A part or all of the sample tube 103 is arranged in the hollow structure inside the magnetic coupling integrated component 101 in a parallel or spiral manner and passes through the windows of the M magnetic cores 102, preferably through the geometric center of the window of the magnetic core 102. Specifically, the sample tube 103 is wound to form one or more turns of annular tubes, and the multiple turns of annular tubes may form a planar spiral or axial spiral structure.

The magnetoelectric effect of the window region of the magnetic core 102 may be defined according to the magnetoelectric coupling intensity to ensure that the liquid sample in each sample tube 103 can optimize the utilization of the magnetoelectric energy of the window region. Specifically, when the apparatus is designed, a center line of the geometrical center of the magnetic core window may be pre-determined in the magnetic core 102 as a reference axis. More specifically, a modular arrangement may be performed, and multiple sample tubes may be evenly distributed in different regions of the window plane of the magnetic core 102, and each segment still passes through the window plane of corresponding magnetic core, ensuring that the liquid sample in each sample tube 103 is located at a central region subjected to the optimum magnetoelectric effect.

Specifically, an induction magnetic flux produced by the magnetic core inductive coil has a largest and most evenly distributed magnetic energy intensity in the window region of the magnetic core 102, and the intensity of the induced electric field and the induced magnetic field of the liquid sample is also most stable. The sample tube is placed in the central region of the magnetic core window to ensure that the liquid sample is in an effective magnetoelectric coupling region, thereby generating an optimal processing effect. By using such a design, the induced electric field strength and the magnetic field strength in or around the liquid sample can be maximized, and excellent effect reproducibility and stability, and low loss are achieved.

More specifically, the sample tube 103 has a feed inlet 105 and a discharge outlet 106. The feed inlet 105 of the sample tube 103 may be connected to a pumping module 401, the discharge outlet 106 is connected to a collection module 501, and the sample tube 103, the pumping module 401, and the collection module 501 are connected to form a passage through which the liquid sample can flow. For example, the liquid sample in the collection module 501 is driven by the pumping module 401 to enter the sample tube 103 from the feed inlet 105 and continuously pass through the magnetic coupling integrated component 101, and then flow out via the discharge outlet 106 and returned or not returned to a mixing module 501.

For example, the sample tube 103 may be made of a temperature-resistant and corrosion-resistant electrical insulating material such as polytetrafluoroethylene (PTFE plastic), an epoxy tube, a resin hose, a perfluoroalkoxy polymer (PFA plastic), polypropylene (PP plastic), polyethylene (PE plastic), fluorinated ethylene propylene copolymer (FEP plastic), resin, silicone, organic glass, high borosilicate glass, or quartz. The pumping module 401 may be a peristaltic pump, a constant-flux pump, a centrifugal pump, a diaphragm pump, a gear pump, a plunger pump, a pressure pump, or a screw pump. The collection module 501 may be a stirred tank, an insulation barrel, a storage tank, a reagent bottle, or a glass beaker known in the art. Both the pumping module 401 and the collection module 501 are devices or articles known in the art, and thus their specific structures and operating principles are not described in further detail here.

In a relatively preferred implementation, the induction magnetic field carrier integrated apparatus for inducting a liquid sample to produce an induced electric/magnetic field may further include a cooling module 301. The cooling module 301 is mainly used to adjust an operating temperature of the magnetic coupling integrated component 101 (specifically, a surface operating temperature of the magnetic core inductive coil).

Specifically, the cooling module 301 can adjust the operating temperature of the magnetic coupling integrated component 101 in a manner of air cooling, semiconductor refrigeration, and a constant temperature bath that are known in the art.

For example, the cooling module 301 may be one, or a combination of more than two, of a fan, an air blower, a semiconductor refrigeration plate, a water-cooling plate, or a constant-temperature bath. The semiconductor refrigeration plate and the water-cooling plate are in direct contact with the magnetic core inductive coil. The magnetic core inductive coil may be immersed in the constant-temperature bath. A refrigerant in the constant-temperature bath may flow in a container that holds the magnetic coupling integrated component and a heat exchange pipeline thereof. The refrigerant in the constant-temperature bath may be water, mineral oil, or other fluid media capable of conducting heat exchange. Certainly, as is known in the art, the heat exchange pipeline may be further connected to a refrigeration compressor/heat sink to improve heat exchange power.

Specifically, the induction magnetic field carrier integrated apparatus for inducting a liquid sample to produce an induced electric/magnetic field further includes a control module 601. The control module 601 is connected to the excitation power supply 201, the cooling module 301, the pumping module 401, and the collection module 501. The control module 601 is used to control and monitor operating parameters of the excitation power supply 201, the cooling module 301, the pumping module 401, and the collection module 501 to make the magnetic coupling integrated component 100 produce an intermediate-frequency induction magnetic flux, and the intermediate-frequency induction magnetic flux may induce production of the induced electric/magnetic field in the liquid sample of the sample tube 103. For example, the control module 601 may be a PLC controller (Programmable Logic Controller), a microcomputer, or the like. Numerical control programs and the like adopted by the control module 601 are all commercially available, and circuit structures in the present disclosure are all implemented by means or technologies known to those skilled in the art, which are not specifically limited herein.

In this embodiment, when physicochemical characteristics of the liquid sample are changed by using the induction magnetic field carrier integrated apparatus for inducing a liquid sample to produce an induced electric/magnetic field, the liquid sample (mainly an electrolyte solution) with an electrical conductivity of 0.01 S/m-18.0 S/m is pumped into the sample tube 103 by using the pumping module 401. The sample tube 103 is filled with the liquid sample, and the liquid sample in the sample tube 103 can flow continuously. The intermediate-frequency induction magnetic flux generated by the magnetic core inductive coil has a magnetic flux density of 0.2 T-1.0 T at a frequency of 5 kHz-100 kHz. The cooling module 301 s can maintain an operating temperature of the magnetic coupling integrated component, that is, the operating temperature of the magnetic core inductive coil (mainly a magnetic core, and the same below) on the surface of the magnetic core inductive coil, at 30° C.-130° C. The intensity of the induced electric/magnetic field of the liquid sample in the sample tube 103 may be detected by the instruments, where the intensity of the induced electric field is measured by inserting a metal probe into the sample tube and connecting the metal probe to an oscilloscope. The intensity of the induced magnetic field is measured by enabling a galvanometer equipped with a Hall sensor to pass through the sample tube and connecting to an oscilloscope. In addition, the intensity E of the induced electric field inside the liquid sample in the sample tube 103 is shown in formula (1):

$$E = ( 2 U \times N ) / l \qquad formula ( 1 )$$

where U is an excitation voltage of the excitation power supply 201, N is the number of the magnetic core inductive coils, and l is an effective magnetic circuit length of the magnetic core inductive coil.

The intensity B of the induced magnetic field of the liquid sample in the sample tube 103 is shown in formula (2):

$$B = \frac{{μ}_{0} I}{2 π r} \qquad formula ( 2 )$$

where μ₀ is vacuum magnetic permeability, with a magnitude of 4π×10⁻⁷ H/m, I is an induced current inside the liquid sample (measured by a galvanometer equipped with a Hall sensor and an oscilloscope), and r is a shortest distance from an axial center of the sample tube 103 to a center of an annular magnetic circuit of the Hall sensor equipped in a galvanometer.

Specifically, under the action of the intermediate-frequency induction magnetic flux, a dynamic magnetoelectric coupling effect between an induced electric field and an induced magnetic field is produced inside the liquid sample tube. The main influencing mechanisms include, but are not limited to, the Lorentz force effect of electromagnetic mutual inductance, molecular rearrangement induced by the magnetic flux, changes in electron cloud distribution, and non-contact transfer of electromagnetic energy. Compared with the prior art, in the present disclosure, the present disclosure employs an integrated combination of a certain number of magnetic circuits arranged in a specific trajectory to form a hollow structure as the specific sample placement region. This configuration enables an electrolyte sample within the sample placement region to simultaneously induce strong induced electric/magnetic fields even at a relatively low operating magnetic flux density. The highly integrated magnetic core inductive coil set ensures uniform magnetic energy distribution in the sample placement region, rendering the changes in the physicochemical characteristics of the liquid sample controllable and reproducible.

The sample treated by the method of the present disclosure exhibits the following performance improvement or special advantages. (1) Conductivity and reaction activity are enhanced, for example, the method is conducive to the improvement of catalytic performance in an electrochemical system, an electrocatalytic solution, or conductive liquid. (2) Rheological property or dispersibility is improved, for example, particle aggregation is reduced, and the stability and fluidity of the medium are enhanced. (3) Interfacial property and reaction activity are controlled, for example, the interfacial activity and reaction rate for emulsion, suspension, and colloid systems can be improved. (4) Orientation stability of a diamagnetic molecular structure is enhanced. (5) Inhibition, inactivation, or enhanced activation of microorganisms or enzymes is achieved. The changed physicochemical characteristics include, but are not limited to, electrical characteristics (such as an electrical conductivity and a dielectric constant), structural characteristics (such as a hydrogen bond association and aggregation state of molecules or particles), thermal characteristics (such as a thermal conductivity and a heat transfer coefficient), reaction characteristics (redox activity, chemical reaction rate, equilibrium constant, free radical generation capability), optical characteristics (such as absorbance and refractive index), and the like.

The present disclosure may be applied to inducing molecular ordered orientation and modulating functional properties in a biochemical sample, a multiphase complex electrolyte medium, or a polymer solution, and applied to fields such as material processing and modification, chemical reaction enhancement, and food and functional liquid processing.

### Embodiment 1

FIG. 1 and FIG. 2 show a structure of an induction magnetic field carrier integrated apparatus for inducing a liquid sample to produce an induced electric/magnetic field provided by this embodiment.

In this embodiment, the magnetic coupling integrated component 101 includes eighteen (N=18) magnetic core inductive coils. Structural configurations of the magnetic core inductive coils are the same. The eighteen magnetic core inductive coils are equidistantly arranged in sequence along a circular trajectory, showing a circular structure as a whole. Windows of the eighteen magnetic core inductive coils are connected to form a circular hollow structure. A window plane of each magnetic core inductive coil intersects a window plane of the circular structure presented by the magnetic coupling integrated component 101 as a whole, and the sample tube 103 passes through windows of the eighteen magnetic core inductive coils.

The winding 104 of the magnetic core inductive coil is a Litz wire, which is wound around winding slots of all eighteen magnetic cores 102 in a parallel configuration with two turns (the number of turns n=2) per magnetic core and is electrically connected to an excitation power supply 201, and an excitation voltage with a frequency f of 50 kHz is applied to the winding 104 by using the excitation power supply 201, a waveform is a square wave, and an intermediate-frequency induction magnetic flux formed by each magnetic core inductive coil is the same. An operating magnetic flux density B of each magnetic core may be obtained according to formula (3):

$$U = 4 \times f \times s \times n \times B \qquad ( 3 )$$

where U is an excitation voltage, f is a frequency, n is the number of turns of the winding of a single magnetic core 102, s is an effective cross-sectional area of a magnetic circuit of the single magnetic core 102, and B is an operating magnetic flux density.

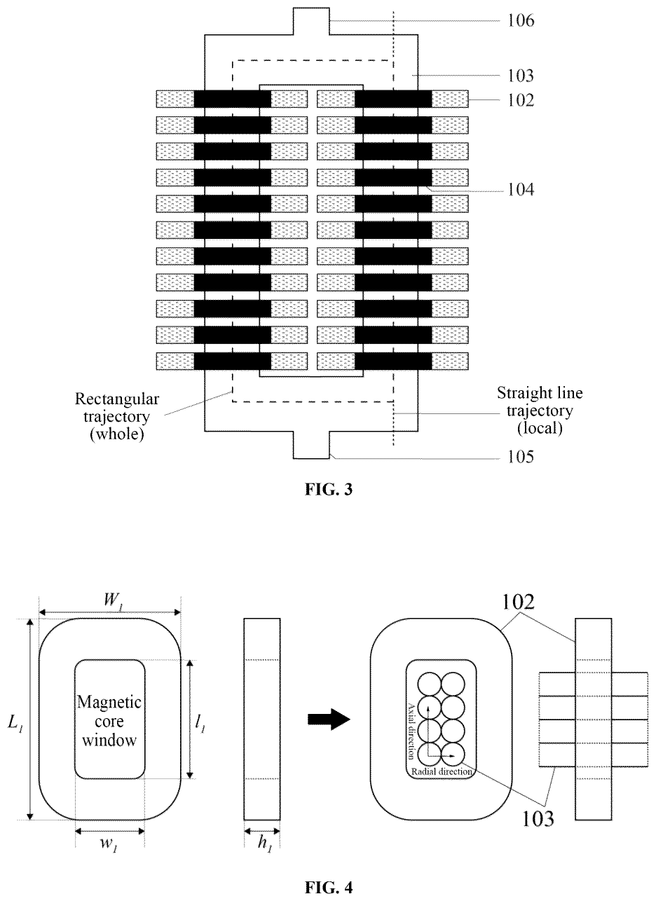

With reference to FIG. 4, the magnetic core 102 is made of amorphous nanocrystalline, the magnetic core 102 is a rectangular-like loop-shaped structure, the magnetic core 102 has an outer side length L₁ of 180 mm, an outer width W₁ of 130 mm, a window plane length l₁ of 100 mm, a window width w₁ of 50 mm, and a thickness h₁ of 20 mm; and an effective magnetic circuit length l of the magnetic core inductive coil is 380 mm, that is, (2l₁+w₁+W₁). The boundaries of the magnetic cores 102 of the eighteen magnetic core inductive coils are arranged circumferentially along a circular trajectory and enclosed in a loop by fasteners, to form a magnetic coupling integrated component 101 with a hollow structure, and a window plane of each magnetic core 102 is perpendicular to a plane enclosed by the circular trajectory, and an effective cross-sectional area of the magnetic circuit of the single magnetic core inductive coil is 8 cm², that is, s=[(W₁−w₁)/2]×h₁.

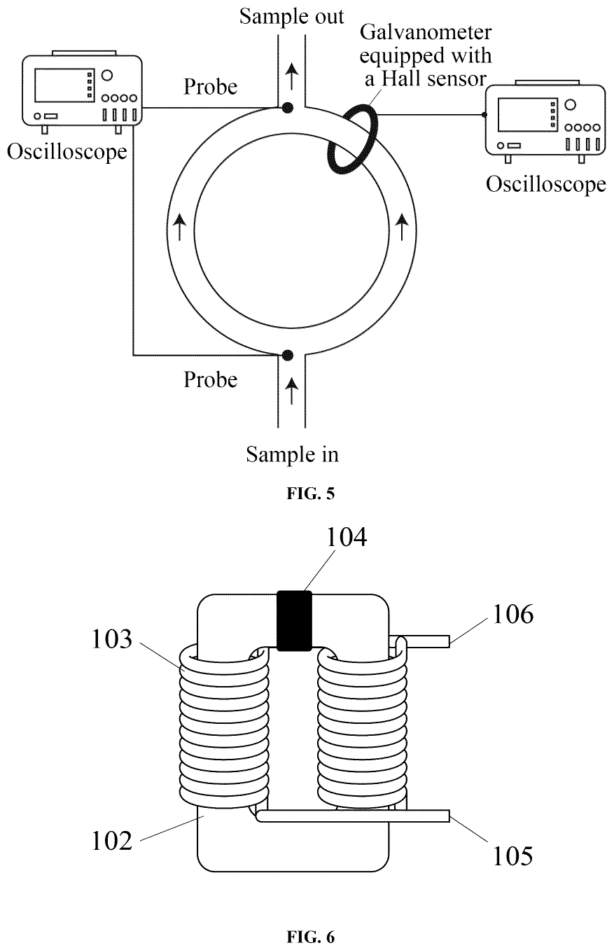

The sample tubes 103 are eight parallel PFA plastic tubes arranged in an overlapping manner, an inner diameter D₁ of the PFA coil tube is 18 mm, and a total radial cross-sectional area of the sample tube 103 is 20.35 cm², that is, 8×π×(D₁/2)². The eight PFA plastic tubes all pass through a window region of each magnetic core inductive coil, and are successively nested/overlapped in an axial direction and a radial direction of a loop-shaped structure formed by the PFA plastic tube, with a layout shown in FIG. 4. Each PFA plastic tube includes one branch structure, and the branch structure forms a closed loop, as shown in FIG. 5. Eight PFA plastic tubes are disposed in one sleeve and are disposed in a circular hollow structure region of the magnetic coupling integrated component 101, and the circular hollow structure region has a center circumference L of 83 cm.

The liquid sample is pumped into the sample tube 103 from the feed inlet 105 by the gear pump until the fluid sample fills the entire sample tube 103, and finally flows out from the discharge outlet 106, an excitation voltage U is regulated to 160 V. In this case, an operating magnetic flux density of the magnetic core inductive coil is 0.5 T, the liquid sample is a mixture of 3% w/v corn starch emulsion and 0.2% w/v dilute hydrochloric acid at a mixing ratio (v/v) of 1:0.3, with an electrical conductivity of 8.3 S/m. A flow rate is adjusted to allow 100 kg liquid sample to continuously pass through the magnetic coupling integrated component 101 for induced electric/magnetic field treatment. During the liquid sample pass through the sample tube 103, a temperature of the sample increases from an initial temperature of 20° C. to a terminal temperature of 98° C., that is, the temperature rise is 78° C., and a temperature rise rate at this time is 7.8° C./min. In addition, an induced magnetic field of the liquid sample filled in the sample tube 103 is detected to be 60 μT with a galvanometer equipped with a Hall sensor connected to an oscilloscope, and an induced electric field in the liquid sample filled in the sample tube 103 is detected to be 151.6 V/cm with a probe connected to the oscilloscope. A detection method and a detection position are shown in FIG. 5. After the treatment, the sample solution flowing out from the discharge outlet 106 is then collected, neutralized to pH=7 with 0.3% NaOH solution, and dried at 55° C. for subsequent analysis.

In this embodiment, the cooling module 301 is a high-power exhaust fan, the eighteen magnetic core inductive coils and the sample tube are fixed in a chamber, a heat dissipation air duct and the sample tube are disposed in an isolated manner, and heat dissipation is achieved via a bottom-air intake and top-air outlet configuration to maintain an operating temperature of the magnetic coupling integrated component 101 at 90±5° C. The operating temperature of the magnetic coupling integrated component 101 is measured by a temperature monitor. For example, the temperature monitor may be a surface-mounted thermocouple, an infrared thermal imaging system, or the like. As is known to those skilled in the art, the surface-mounted thermocouple is attached to a surface of each magnetic core inductive coil, and temperature data is recorded via a data line, displayed in real time, and further analyzed and determined by a microcomputer. The infrared thermal imaging system is placed at a certain distance from the magnetic coupling integrated component 101 to observe a temperature distribution condition of each magnetic core inductive coil, and the temperature data is transmitted to the microcomputer in real time for analysis and determination. The heat dissipation power of the cooling module 301, as well as the input power and active power (that is, heating power) of the excitation power supply 201 can be measured by connecting a power meter.

In this embodiment, the sample before and after treatment is evaluated based on the following indices: gel strength (the gel strength (expressed in g·cm) is determined using a texture analyzer with reference to a method disclosed in the article entitled Effects of salts on the freeze-thaw stability, gel strength and rheological properties of potato starch by WANG Wei, ZHOU Hongxian, YANG Hong, and CUI Min in [J]. Journal of Food Science and Technology, 2016, 53(9): 3624-3631.), cold water solubility (the cold water solubility (expressed in %) is determined with reference to the method disclosed in the article entitled Characteristics of granular cold-water-soluble potato starch treated with alcohol and alkali by CHOI Ye-Jin and BAIK Moo-Yeol in [J]. Food Science and Biotechnology, 2017, 26(5): 1263-1270.), water holding capacity (the water holding capacity (expressed in %) is determined with reference to the method disclosed in the article entitled Insight into the effect of garlic peptides on the physicochemical and anti-staling properties of wheat starch by Xie, Q., Liu, X., Liu, H., Zhang, Y., Xiao, S., Ding, W., . . . & Wang, X. (2023) in International Journal of Biological Macromolecules, 2023, 229:363-371), a temperature rise rate (° C./min) per 100 kg of sample during treatment, an intensity (V/cm) of an induced electric field in the sample, an intensity (μT) of an induced magnetic field of the sample in the sample tube, input power (kW), heating power (kW), heat dissipation power (kW), and energy efficiency (%, calculated by dividing the heating power by the input power and then multiplying by 100). As shown in Table 1, the sample treated with the induction magnetic field carrier integrated apparatus described in Embodiment 1, namely acid-modified starch (or pregelatinized starch), exhibits significant changes in performance indices such as the gel strength, the cold water solubility and the water holding capacity, and functionality is greatly improved.

### Comparative Example 1

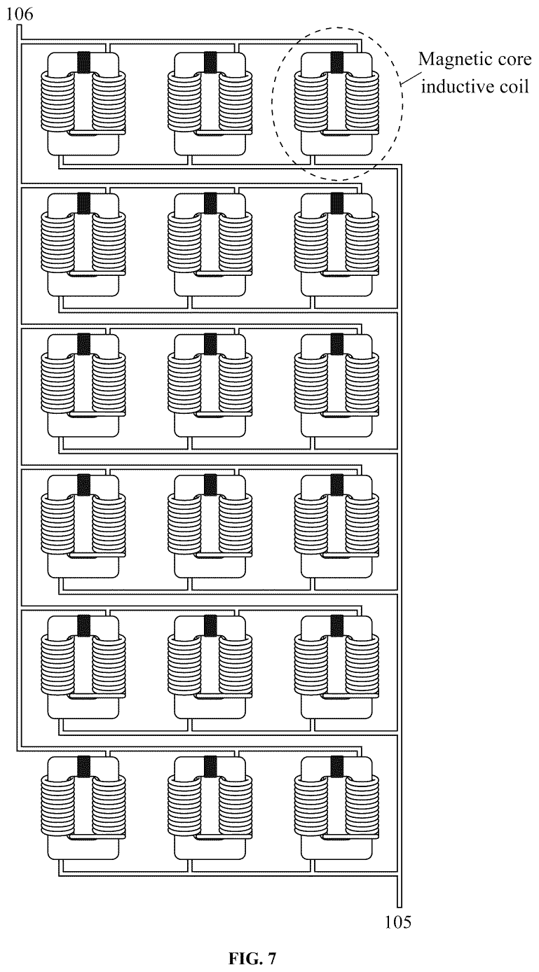

This comparative example refers to Embodiment 1, eighteen monolithic magnetic core structures (for example, a structure disclosed in US20250244290A1) are employed in this comparative example, as shown in FIG. 6. A liquid sample (a mixture of 3% w/v corn starch milk and 0.2% w/v dilute hydrochloric acid), a sample electrical conductivity, treatment capacity, an initial temperature, a terminal temperature, and the quantity, dimension, size and material of the magnetic core inductive coil, turns of Litz wire winding (n=2), applied frequency, and an electrical connection mode are all consistent with those in Embodiment 1. However, these magnetic core inductive coils are independently configured in a parallel mode and connected to the excitation power supply, as shown in FIG. 7, without employing a magnetic coupling integrated component structure of the present disclosure.

In this comparative example, the sample tube 103 is a multi-layer PFA coil tube with spiral distribution. An inner diameter of the PFA coil tube is 8 mm, and the sample tube 103 is separately wound around left and right sides of the magnetic core 102. The total liquid holding capacity of the sample tubes 103 of the eighteen magnetic core inductive coils is ensured to be consistent with that in Embodiment 1, that is, a sample volume during magneto-electric coupling treatment is the same. In addition, an excitation voltage of 320 V different from that in Embodiment 1 is adopted for excitation, in this case, these magnetic core inductive coils operate at a saturated operating magnetic flux density of 1 T. A flow rate is adjusted to ensure that the 100 kg of liquid sample can reach a terminal temperature of 98° C. as in Embodiment 1 during the sample flowing through the sample tube 103, in this case, a temperature rise rate is merely 4.0° C./min. In addition, an induced magnetic field of the liquid sample in the sample tube 103 is detected to be 10 μT with a galvanometer equipped with a Hall sensor connected to an oscilloscope, and an induced electric field in the liquid sample in the sample tube 103 is detected to be 33.7 V/cm with a probe connected to the oscilloscope. A detection method and a detection position are shown in FIG. 8. After the treatment, the sample solution flowing out from the discharge outlet 106 is then collected, neutralized to pH=7 with 0.3% NaOH solution, and dried at 55° C. for subsequent analysis.

In this comparative example, the sample before and after treatment is evaluated based on the following indices: gel strength, cold water solubility, water holding capacity, a temperature rise rate per 100 kg of sample during treatment, an intensity of the induced electric field in the sample, an intensity of the induced magnetic field of the sample in the sample tube, input power, heating power, heat dissipation power, and energy efficiency (calculated by dividing the heating power by the input power and then multiplying by 100). A determination method is the same as that in Embodiment 1.

TABLE 1
Comparison of application effects of Embodiment
1 and Comparative Example 1

| | | Embodiment | Comparative |
|---|---|---|---|
| Parameters | Unit | 1 | Example 1 |
| Processing volume of liquid | kg | 100.0 | 100.0 |
| sample | | | |
| Initial temperature (that is, inlet | ° C. | 20.0 | 20.0 |
| temperature) | | | |
| Terminal temperature (that is, | ° C. | 98.0 | 98.0 |
| outlet temperature) | | | |
| Residence time | min | 10 | 19.5 |
| Temperature rise rate per 100 kg of | ° C./min | 7.8 | 4.0 |
| sample | | | |
| Intensity of induced electric field | V/cm | 151.6 | 33.7 |
| Intensity of induced magnetic field | μT | 60.0 | 10.0 |
| Input power | kW | 62.0 | 100.0 |
| Heating power | kW | 54.6 | 28.0 |
| Heat dissipation power | kW | 10.6 | 45.3 |
| Energy efficiency | % | 88.1 | 28.0 |
| Gel strength (before treatment) | g · cm | 100.0 | 100.0 |
| Gel strength (after treatment) | g · cm | 150.0 | 140.0 |
| Cold water solubility (before | % | 3.0 | 3.0 |
| treatment) | | | |
| Cold water solubility (after | % | 89.0 | 82.0 |
| treatment) | | | |
| Water holding capacity (before | % | 83% | 83% |
| treatment) | | | |
| Water holding capacity (after | % | 94% | 89% |
| treatment) | | | |

A comparison of the results of Comparative Example 1 and Embodiment 1 is shown in Table 1. It can be seen that under the conditions that the quantity and electrical parameters of magnetic core inductive coils, magnetic core material and its dimensional configuration are all the same, the form of the magnetic coupling integrated component is not employed (that is, a structural configuration of the integrated magnetic core inductive coil in Embodiment 1 is not employed), when samples of the same nature and mass are treated as well as the initial and terminal temperatures of the samples are the same, a temperature rise rate, energy efficiency, and the intensity of the induced electric/magnetic field of Comparative Example 1, as well as the gel strength, cold water solubility, water holding capacity, and the like of the treated sample (that is, the acid-modified starch), are all inferior to those in Embodiment 1. In addition, Comparative Example 1 exhibits higher heat dissipation power, indicating that the apparatus in Comparative Example 1 has greater energy loss. The reason is that, to achieve the same terminal sample temperature (that is, treatment temperature) as in Embodiment 1, the magnetic core inductive coil operates close to a saturation magnetic flux density point, leading to higher heat loss, lower active power, slower temperature rise of the sample solution, and then poor energy utilization efficiency.

### Embodiment 2

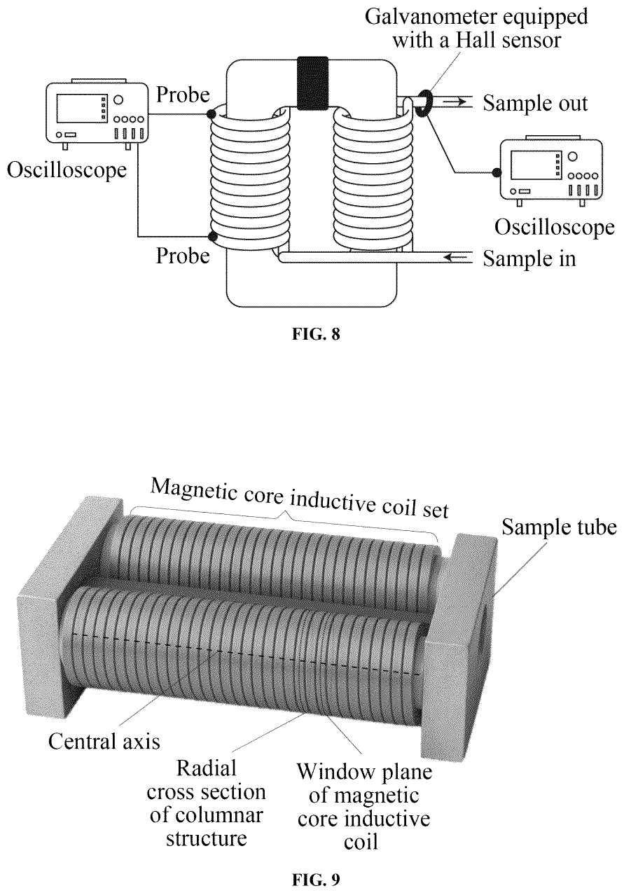

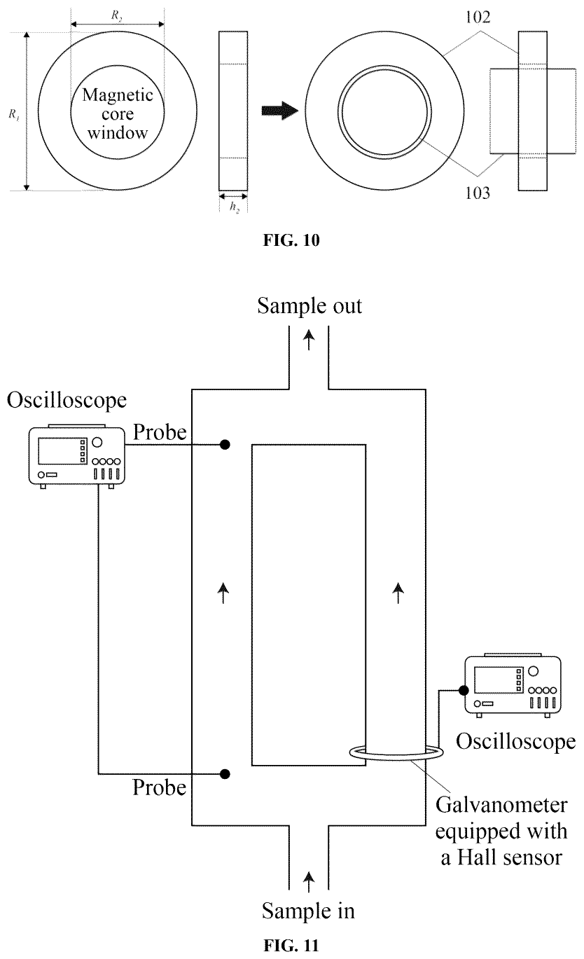

With reference to Embodiment 1, an induction magnetic field carrier integrated apparatus for inducing a liquid sample to produce an induced electric/magnetic field provided by this embodiment is basically the same as that in Embodiment 1. The difference from Embodiment 1 is that, as shown in FIG. 3, magnetic core inductive coils in the magnetic coupling integrated component in this embodiment are arranged along two long sides of a rectangular trajectory in a spaced manner, and then the magnetic coupling integrated component is configured as two parallel columnar structures as a whole. A shape of each magnetic core inductive coil or each magnetic core is in a circular shape, which may be understood as follows: the magnetic core inductive coils are spaced apart along two parallel straight line trajectories, a window plane of the magnetic core inductive coil is parallel to a radial cross section of the columnar structure, and a central axis of each columnar structure coincides with that of a hollow structure in the columnar structure. The sample tube 103 passes through a window region of each magnetic core inductive coil. A perspective structure of the magnetic coupling integrated component in this embodiment is shown in FIG. 9.

In this embodiment, the magnetic coupling integrated component 101 includes eighty (N=80) magnetic core inductive coils. The eighty magnetic core inductive coils are divided into two magnetic core inductive coils sets on the left and right. Each magnetic core inductive coil set includes forty magnetic core inductive coils (M=40). The two magnetic core inductive coils sets are arranged and distributed along two long sides of the rectangular trajectory, respectively. The boundaries of the magnetic cores 102 of the magnetic core inductive coils are arranged in parallel and in an overlapping manner at a spacing of 6 mm via fasteners to form an integrated magnetic circuit structure together with the sample tube 103, that is, the magnetic coupling integrated component 101 configured as a rectangular annular structure as a whole.

In this embodiment, the winding 104 of the magnetic core inductive coil is a Litz wire, which is wound around winding slots of all eighty magnetic cores 102 in a parallel configuration with two turns (the number of turns n=2) per magnetic core and is electrically connected to an excitation power supply 201, and an excitation voltage with a frequency f of 60 kHz is applied to the winding 104 by using the excitation power supply 201, and a waveform is a sine wave. An operating magnetic flux density B of each magnetic core may be obtained according to formula (4):

$$U = 4.443 \times f \times s \times n \times B , \qquad ( 4 )$$

where U is an excitation voltage, f is a frequency, n is the number of turns of the winding of a single magnetic core 102, s is an effective cross-sectional area of a magnetic circuit of the single magnetic core 102, and B is an operating magnetic flux density.

With reference to FIG. 10, the magnetic core 102 is made of an amorphous nanocrystalline, the magnetic core 102 is of a circular structure, an outer ring and an inner ring (a window region) of the radial cross section of the magnetic core 102 are both circular, a diameter R₁ of the outer ring is 130 mm, a diameter R₂ of the inner ring is 110 mm, and an axial thickness h₂ is 20 mm. An effective magnetic circuit length l of the magnetic core inductive coil is 377 mm, that is, π×[(R₁−R₂)/2+R₂], and an effective cross-sectional area of a magnetic circuit of a single magnetic core inductive coil is 2 cm², that is, s=[(R₁−R₂)/2]×h₂.

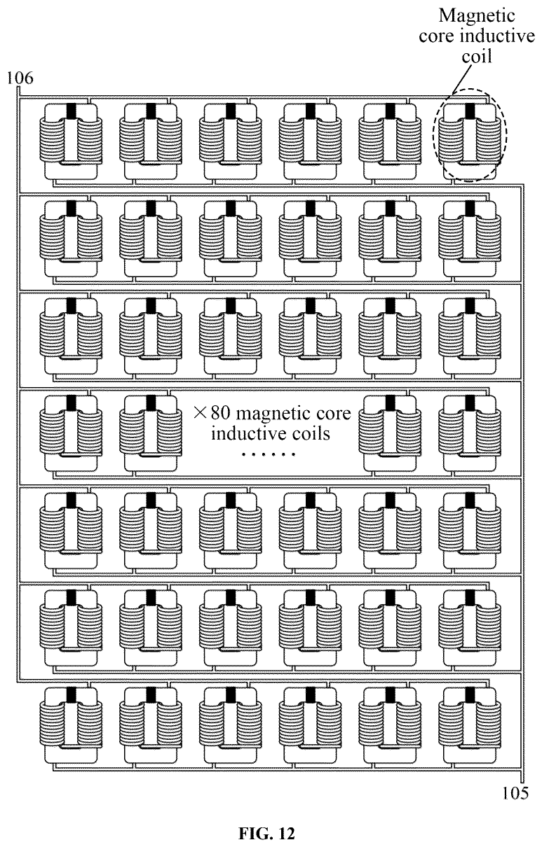

With reference to FIG. 3, the sample tube 103 refers to two parallel high-borosilicate glass tubes. The glass tube has an outer diameter of 98 mm, an inner diameter of 95 mm, and a radial cross-sectional area of 70.88 cm², that is, s=π×(95/2)². The two glass tubes pass through window regions of forty magnetic core inductive coils 102 in each set in parallel, separately, that is, the two glass tubes pass through two columnar hollow structure regions of the magnetic coupling integrated component 101, and the two glass tubes are interconnected at both ends. A feed inlet 105 and a discharge outlet 106 are respectively arranged at midpoints of two connection positions. Specifically, the sample tube 103 includes a branch structure which forms a closed loop, as shown in FIG. 11. A total length L of the two columnar hollow structures of the magnetic coupling integrated component 101 is 210 cm, that is, a length of a single columnar hollow structure is that L/2=105 cm.

The liquid sample is pumped into the sample tube 103 from the feed inlet 105 by a screw pump until the fluid sample fills the entire sample tube 103, and finally flows out from the discharge outlet 106. An excitation voltage U is adjusted to 32 V, and in this case, an operating magnetic flux density of the magnetic core inductive coil is 0.3 T. Pectin derived from citrus peels (industrial-grade high-methoxyl citrus pectin) is selected as a raw material and mixed with 0.5% citric acid solution, where a solid-liquid ratio is 1:35 (g/mL) to ensure that the pectin is fully dispersed to form the liquid sample, which has an initial pH of 2.8 and an electrical conductivity of 0.3 S/m. A flow rate is adjusted to allow 100 kg of the sample solution to continuously pass through the magnetic coupling integrated component 101 for induced electric/magnetic field treatment to ensure that, during the liquid sample flowing through the sample tube 103, a temperature of the sample increases from an initial temperature of 10° C. to a terminal temperature of 70° C., that is, the temperature rise is 60° C., and a temperature rise rate at this time is 20° C./min. In addition, an induced magnetic field of the liquid sample in the sample tube 103 is detected to be 30 μT with a galvanometer equipped with a Hall sensor connected to an oscilloscope, and an induced electric field in the liquid sample in the sample tube 103 is detected to be 135.8 V/cm with a probe connected to the oscilloscope. A detection method and a detection position are shown in FIG. 11. After the treatment, the sample solution flowing out from the discharge outlet 106 is collected, neutralized to pH=7 with 0.5% NaOH solution, and dried at 50° C. for subsequent analysis.

In this embodiment, the cooling module 301 employs a high-pressure fan for heat dissipation, the eighty magnetic core inductive coils and the sample tube are fixed in a chamber, a heat dissipation air duct and the sample tube are disposed in an isolated manner, and heat dissipation is achieved via a bottom-air intake and top-air outlet configuration, thereby maintaining an operating temperature of the magnetic coupling integrated component 101 at 90±5° C. The operating temperature of the magnetic coupling integrated component 101 is measured by a temperature monitor. For example, the temperature monitor may be a surface-mounted thermocouple, an infrared thermal imaging system, or the like. As is known to those skilled in the art, the surface-mounted thermocouple is attached to a surface of each magnetic core inductive coil, and temperature data is recorded via a data line, displayed in real time, and further analyzed and determined by a microcomputer. The infrared thermal imaging system is placed at a certain distance from the magnetic coupling integrated component 101 to observe a temperature distribution condition of each magnetic core inductive coil, and the temperature data is transmitted to the microcomputer in real time for analysis and determination. The heat dissipation power of the cooling module 301, as well as the input power and active power (that is, heating power) of the excitation power supply 201 can be measured by connecting a power meter.

In this embodiment, the sample before and after treatment is evaluated based on the following indices: a polydispersity index (PDI value, that is, a molecular weight distribution coefficient may refer to The use of high-performance size exclusion chromatography (HPSEC) as a molecular weight screening technique for polygalacturonic acid for use in pharmaceutical applications by White, G. W., Katona, T., & Zodda, J. P. (1999) in Journal of pharmaceutical and biomedical analysis, 20 (6), and 905-912.), cold water solubility, gel strength, a temperature rise rate per 100 kg of sample during treatment, an intensity of an induced electric field in the sample, an intensity of an induced magnetic field of the sample in the tube sample, input power, heating power, heat dissipation power, and energy efficiency (calculated by dividing the heating power by the input power and then multiplying by 100), where a method for determining the cold water solubility and the gel strength is the same as that in Embodiment 1. Results are shown in Table 2, a modified pectin sample obtained by treating with the induction magnetic field carrier integrated apparatus in Embodiment 2 exhibits significant changes in performance indices such as the polydispersity index, the cold water solubility and the gel strength, and then the functionality is greatly enhanced.

### Comparative Example 2

This comparative example refers to Embodiment 2, eighty monolithic magnetic core structures (for example, a structure disclosed in US20250244290A1) are employed in this comparative example, as shown in FIG. 6. A liquid sample (a pectin solution derived from citrus peels), a sample electrical conductivity, treatment capacity, an initial temperature, a terminal temperature, as well as the quantity, dimension, size and material of the magnetic core inductive coil, turns of Litz wire winding (n=2), applied frequency, and an electrical connection mode are all consistent with those in Embodiment 2. However, these magnetic core inductive coils are independently configured in a parallel mode and connected to the excitation power supply, as shown in FIG. 12, without employing a magnetic coupling integrated component structure of the present disclosure.

In this comparative example, the sample tube 103 is a multi-layer PFA coil tube with spiral distribution. An inner diameter of the PFA coil tube is 8 mm, and the sample tube 103 is separately wound around left and right sides of the magnetic core 102. The total liquid holding capacity of the sample tubes 103 of the eighty magnetic core inductive coils is ensured to be consistent with that in Embodiment 2, that is, a sample volume during magneto-electric coupling treatment is the same. In addition, an excitation voltage of 107 V different from that in Embodiment 2 is adopted for excitation, in this case, the magnetic core inductive coil operates at a saturated operating magnetic flux density of 1 T. A flow rate is adjusted to ensure that the 100 kg of liquid sample can reach a terminal temperature of 70° C. as in Embodiment 2 during the sample solution flowing through the sample tube 103, in this case, a temperature rise rate is merely 12.0° C./min. In addition, an induced magnetic field of the liquid sample in the sample tube 103 is detected to be 6 μT with a galvanometer equipped with connected to an oscilloscope, and an induced electric field in the liquid sample in the sample tube 103 is detected to be 24.5 V/cm with a probe connected to the oscilloscope. A detection method and a detection position are shown in FIG. 8. After the treatment, the sample solution flowing out from the discharge outlet 106 is collected for subsequent analysis.

In this comparative example, the sample before and after treatment is evaluated based on the following indices: a polydispersity index (PDI value, that is, a molecular weight distribution coefficient), cold water solubility, gel strength, a temperature rise rate per 100 kg of sample during treatment, an intensity of the induced electric field in the sample, an intensity of the induced magnetic field of the sample in the sample tube, input power, heating power, heat dissipation power, and energy efficiency (calculated by dividing the heating power by the input power and then multiplying by 100). A determination method is the same as that in Embodiment 2.

A comparison of the results of Comparative Example 2 and Embodiment 2 is shown in Table 2. It can be seen that under the conditions that the quantity and electrical parameters magnetic core inductive coils, magnetic core material and its dimensional configuration are all the same, the form of the magnetic coupling integrated component is not employed, that is, a structural configuration of the integrated magnetic core inductive coil in Embodiment 1 is not employed. When samples of the same nature and mass are treated as well as the initial and terminal temperatures of the samples are the same, a temperature rise rate, energy efficiency, and the intensity of the induced electric/magnetic field of Comparative Example 2, as well as the functional characteristics of the treated pectin, are all inferior to those in Embodiment 2. In addition, Comparative Example 2 exhibits higher heat dissipation power, indicating that the apparatus in Comparative Example 2 has greater energy loss. The reason is that, to achieve the same terminal sample temperature (that is, treatment temperature) as in Embodiment 2, the magnetic core inductive coil operates close to a saturation magnetic flux density point, leading to higher heat loss, lower active power, small temperature rise of the sample solution, and then poor energy utilization efficiency.

TABLE 2
Comparison of application effects of Embodiment 2 and
Comparative Example 2

| | | Embodiment | Comparative |
|---|---|---|---|
| Parameters | Unit | 2 | Example 2 |
| Processing volume of liquid | kg | 100.0 | 100.0 |
| sample | | | |
| Initial temperature (that is, | ° C. | 10.0 | 10.0 |
| inlet temperature) | | | |
| Terminal temperature (that | ° C. | 70.0 | 70.0 |
| is, outlet temperature) | | | |
| Residence time | min | 3.0 | 5.0 |
| Temperature rise rate per | ° C./min | 20.0 | 12.0 |
| 100 kg of sample | | | |
| Intensity of induced electric | V/cm | 135.8 | 24.5 |
| field | | | |
| Intensity of induced | μT | 30.0 | 6.0 |
| magnetic field | | | |
| Input power | kW | 155.0 | 280.0 |
| Heating power | kW | 140.0 | 84.0 |
| Heat dissipation power | kW | 30.8 | 65.5 |
| Energy efficiency | % | 90.3 | 30.0 |
| Polydispersity index PDI | — | 3.2 | 3.2 |
| (before treatment) | | | |
| Polydispersity index PDI | — | 1.7 | 2.0 |
| (after treatment) | | | |
| Cold water solubility | % | 15.4 | 15.4 |
| (before treatment) | | | |
| Cold water solubility (after | % | 92.6 | 88.0 |
| treatment) | | | |
| Gel strength (before | g · cm | 80.0 | 80.0 |
| treatment) | | | |
| Gel strength (after | g · cm | 210.0 | 170.0 |
| treatment) | | | |

A comparison between Embodiment 2 and Embodiment 1 shows that the magnetic core inductive coils feature a concentrated structural design, so that the energy efficiency of the induction magnetic field carrier integrated apparatus is relatively high.

In conclusion, compared with the apparatuses having the same number of independently arranged magnetic core inductive coils as adopted in the Comparative Example, the magnetic coupling integrated component in the embodiments of the present disclosure employs a brand-new structural principle, which significantly improves the energy efficiency (by approximately 3 times).

It should be understood that the foregoing embodiments are merely used to describe the technical concepts and features of the present disclosure, and are intended to enable a person skilled in the art to understand and implement the content of the present disclosure and not intended to limit the scope of protection of the present disclosure. Any equivalent change or modification made in accordance with the spirit of the present disclosure shall fall within the scope of protection of the present disclosure.

What is claimed is:

1. An induction magnetic field carrier integrated apparatus for inducing a liquid sample to produce an induced electric/magnetic field, comprising:
a magnetic coupling integrated component, comprising N magnetic core inductive coils, wherein the N magnetic core inductive coils are assembled into one or more magnetic core inductive coil sets, M magnetic core inductive coils of the magnetic core inductive coil set are disposed in sequence along a selected trajectory, windows of the M magnetic core inductive coils of the magnetic core inductive coil set are connected in sequence to form a hollow structure, the magnetic core inductive coil comprises a magnetic core and a winding wound around the magnetic core, the winding is electrically connected to a power supply, and the winding is configured to enable the magnetic core inductive coil to convert a current provided by the power supply into an intermediate-frequency induction magnetic flux; and
at least one sample tube, wherein at least a part of the sample tube is disposed in the hollow structure of the magnetic coupling integrated component and passes through the windows of the M magnetic core inductive coils, the sample tube is configured to hold the liquid sample and allow continuous flow of the liquid sample, and the intermediate-frequency induction magnetic flux is capable of inducing production of the induced electric/magnetic field in or around the liquid sample in the sample tube, N>=M>=2.

2. The induction magnetic field carrier integrated apparatus for inducing the liquid sample to produce the induced electric/magnetic field according to claim 1, wherein structural configurations of the N magnetic core inductive coils are the same or different, and the intermediate-frequency induction magnetic fluxes produced by the N magnetic core inductive coils are the same or different;
preferably, the intermediate-frequency induction magnetic flux formed by a single magnetic core inductive coil has an operating magnetic flux density of 0.2 T-1.0 T and a magnetic field frequency of 5 kHz-100 kHz;
preferably, the intermediate-frequency induction magnetic flux is an alternating magnetic field or a pulsed magnetic field; and
preferably, a waveform of an excitation voltage of the intermediate-frequency induction magnetic flux is one, or a combination of more than two of, a sawtooth wave, a spike wave, a square wave, a pulse wave, and a sine wave.

3. The induction magnetic field carrier integrated apparatus for inducing the liquid sample to produce the induced electric/magnetic field according to claim 1, wherein an effective cross-sectional area of a magnetic circuit of a single magnetic core inductive coil in the magnetic coupling integrated component is 0.8 cm²-200 cm².

4. The induction magnetic field carrier integrated apparatus for inducing the liquid sample to produce the induced electric/magnetic field according to claim 1, wherein the selected trajectory is a closed geometric trajectory, a window plane of the magnetic core inductive coil is in a non-parallel state with a plane enclosed by the closed geometric trajectory, and the magnetic core inductive coil set has a loop-shaped structure as a whole;
preferably, the closed geometric trajectory is a planar geometric trajectory, and the planar geometric trajectory is a regular geometric trajectory or an irregular geometric trajectory;
preferably, the regular geometric trajectory comprises a circular trajectory or a polygonal trajectory;
preferably, the selected trajectory is the circular trajectory, the loop-shaped structure is a circular structure, the M magnetic core inductive coils are radially arranged with a geometric center of the circular trajectory as a center, and the window plane of the magnetic core inductive coil intersects a plane enclosed by the circular trajectory;
the selected trajectory is a rectangular trajectory, the loop-shaped structure is a rectangular loop-shaped structure, the M magnetic core inductive coils are disposed in sequence in a long-side direction and/or a wide-side direction of the rectangular trajectory, and the window plane of the magnetic core inductive coil intersects a plane enclosed by the rectangular trajectory; or
the selected trajectory is a rectangular trajectory, the loop-shaped structure is a rectangular loop-shaped structure, the M magnetic core inductive coils are radially arranged with a geometric center of the rectangular trajectory as the center, and the window plane of the magnetic core inductive coil intersects a plane enclosed by the rectangular trajectory.

5. The induction magnetic field carrier integrated apparatus for inducing the liquid sample to produce the induced electric/magnetic field according to claim 1, wherein the selected trajectory is a linear trajectory, the window plane of the magnetic core inductive coil is parallel to a radial cross section of the hollow structure, and the magnetic core inductive coil set has a columnar structure; and
preferably, the selected trajectory is a straight line trajectory, and a central axis of the hollow structure is parallel to the straight line trajectory.

6. The induction magnetic field carrier integrated apparatus for inducing the liquid sample to produce the induced electric/magnetic field according to claim 1, wherein the sample tube passes through of windows of M magnetic cores in the magnetic core inductive coil set; and/or
a portion of the sample tube located inside the hollow structure is of a columnar structure, a loop-shaped structure, or a spiral structure; and/or
a portion of the sample tube located inside the hollow structure comprises one or more annular tube segments, and the plurality of annular tube segments are formed by winding the sample tube into a planar-spiral or axial-spiral configuration;
preferably, the plurality of annular tube segments are disposed in sequence in an axial direction of a loop-shaped structure/spiral structure formed thereby, or are disposed in sequence in a radial direction of the loop-shaped structure/spiral structure formed thereby; and/or
a portion of the sample tube located inside a hollow region of the magnetic coupling integrated component comprises one or more cylindrical tube segments, and the plurality of cylindrical tube segments are formed by disposing the sample tube in parallel; and/or
the sample tube comprises one or more branch structures, and the branch structure forms a closed loop; and/or
the sample tube is disposed in a sleeve, and the sleeve is disposed in the hollow structure.

7. The induction magnetic field carrier integrated apparatus for inducing the liquid sample to produce the induced electric/magnetic field according to claim 1, further comprising a cooling module, wherein the cooling module is configured to adjust an operating temperature of the magnetic coupling integrated component.

8. A method for changing physicochemical characteristics of a liquid sample, comprising:
providing the induction magnetic field carrier integrated apparatus for inducing the liquid sample to produce the induced electric/magnetic field according to claim 1; and
loading the liquid sample into the sample tube, and connecting windings of the N magnetic core inductive coils to the power supply to form the intermediate-frequency induction magnetic flux in each magnetic core inductive coil, wherein the intermediate-frequency induction magnetic flux induces production of the induced electric/magnetic field in or around the liquid sample in the sample tube.

9. The method for changing the physicochemical characteristics of the liquid sample according to claim 8, wherein the intermediate-frequency induction magnetic flux formed by a single magnetic core inductive coil has an operating magnetic flux density of 0.2 T-1.0 T and a frequency of 5 kHz-100 kHz; and an induced electric field of the liquid sample has an electric field intensity of 0.1 V/cm-300 V/cm, and an induced magnetic field of the liquid sample has a magnetic field intensity of 1 μT-200 μT;
preferably, the intermediate-frequency induction magnetic flux is an alternating magnetic field or a pulsed magnetic field;
preferably, a waveform of an excitation voltage of the intermediate-frequency induction magnetic flux is one, or a combination of more than two of, a sawtooth wave, a spike wave, a square wave, a pulse wave, and a sine wave; and/or
the liquid sample has an electrical conductivity of 0.01 S/m-18.0 S/m; and/or
the method for changing the physicochemical characteristics of the liquid sample comprises: keeping the liquid sample in a stationary or flowing state in the sample tube.

10. The method for changing the physicochemical characteristics of the liquid sample according to claim 8, further comprising keeping an operating temperature of the magnetic coupling integrated component at 30° C.-130° C.

11. The induction magnetic field carrier integrated apparatus for inducing the liquid sample to produce the induced electric/magnetic field according to claim 2, wherein an effective cross-sectional area of a magnetic circuit of the single magnetic core inductive coil in the magnetic coupling integrated component is 0.8 cm²-200 cm².

12. The induction magnetic field carrier integrated apparatus for inducing the liquid sample to produce the induced electric/magnetic field according to claim 4, wherein the sample tube passes through of windows of M magnetic cores in the magnetic core inductive coil set; and/or
a portion of the sample tube located inside the hollow structure is of a columnar structure, a loop-shaped structure, or a spiral structure; and/or
a portion of the sample tube located inside the hollow structure comprises one or more annular tube segments, and the plurality of annular tube segments are formed by winding the sample tube into a planar-spiral or axial-spiral configuration;
preferably, the plurality of annular tube segments are disposed in sequence in an axial direction of a loop-shaped structure/spiral structure formed thereby, or are disposed in sequence in a radial direction of the loop-shaped structure/spiral structure formed thereby; and/or
a portion of the sample tube located inside a hollow region of the magnetic coupling integrated component comprises one or more cylindrical tube segments, and the plurality of cylindrical tube segments are formed by disposing the sample tube in parallel; and/or
the sample tube comprises one or more branch structures, and the branch structure forms a closed loop; and/or
the sample tube is disposed in a sleeve, and the sleeve is disposed in the hollow structure.

13. The induction magnetic field carrier integrated apparatus for inducing the liquid sample to produce the induced electric/magnetic field according to claim 5, wherein the sample tube passes through of windows of M magnetic cores in the magnetic core inductive coil set; and/or
a portion of the sample tube located inside the hollow structure is of a columnar structure, a loop-shaped structure, or a spiral structure; and/or
a portion of the sample tube located inside the hollow structure comprises one or more annular tube segments, and the plurality of annular tube segments are formed by winding the sample tube into a planar-spiral or axial-spiral configuration;
preferably, the plurality of annular tube segments are disposed in sequence in an axial direction of a loop-shaped structure/spiral structure formed thereby, or are disposed in sequence in a radial direction of the loop-shaped structure/spiral structure formed thereby; and/or
a portion of the sample tube located inside a hollow region of the magnetic coupling integrated component comprises one or more cylindrical tube segments, and the plurality of cylindrical tube segments are formed by disposing the sample tube in parallel; and/or
the sample tube comprises one or more branch structures, and the branch structure forms a closed loop; and/or
the sample tube is disposed in a sleeve, and the sleeve is disposed in the hollow structure.

14. The method for changing the physicochemical characteristics of the liquid sample according to claim 8, wherein in the induction magnetic field carrier integrated apparatus for inducing the liquid sample to produce the induced electric/magnetic field, structural configurations of the N magnetic core inductive coils are the same or different, and the intermediate-frequency induction magnetic fluxes produced by the N magnetic core inductive coils are the same or different;
preferably, the intermediate-frequency induction magnetic flux formed by a single magnetic core inductive coil has an operating magnetic flux density of 0.2 T-1.0 T and a magnetic field frequency of 5 kHz-100 kHz;
preferably, the intermediate-frequency induction magnetic flux is an alternating magnetic field or a pulsed magnetic field; and
preferably, a waveform of an excitation voltage of the intermediate-frequency induction magnetic flux is one, or a combination of more than two of, a sawtooth wave, a spike wave, a square wave, a pulse wave, and a sine wave.

15. The method for changing the physicochemical characteristics of the liquid sample according to claim 8, wherein in the induction magnetic field carrier integrated apparatus for inducing the liquid sample to produce the induced electric/magnetic field, an effective cross-sectional area of a magnetic circuit of a single magnetic core inductive coil in the magnetic coupling integrated component is 0.8 cm²-200 cm².

16. The method for changing the physicochemical characteristics of the liquid sample according to claim 8, wherein in the induction magnetic field carrier integrated apparatus for inducing the liquid sample to produce the induced electric/magnetic field, the selected trajectory is a closed geometric trajectory, a window plane of the magnetic core inductive coil is in a non-parallel state with a plane enclosed by the closed geometric trajectory, and the magnetic core inductive coil set has a loop-shaped structure as a whole;
preferably, the closed geometric trajectory is a planar geometric trajectory, and the planar geometric trajectory is a regular geometric trajectory or an irregular geometric trajectory;
preferably, the regular geometric trajectory comprises a circular trajectory or a polygonal trajectory;
preferably, the selected trajectory is the circular trajectory, the loop-shaped structure is a circular structure, the M magnetic core inductive coils are radially arranged with a geometric center of the circular trajectory as a center, and the window plane of the magnetic core inductive coil intersects a plane enclosed by the circular trajectory;
the selected trajectory is a rectangular trajectory, the loop-shaped structure is a rectangular loop-shaped structure, the M magnetic core inductive coils are disposed in sequence in a long-side direction and/or a wide-side direction of the rectangular trajectory, and the window plane of the magnetic core inductive coil intersects a plane enclosed by the rectangular trajectory; or
the selected trajectory is a rectangular trajectory, the loop-shaped structure is a rectangular loop-shaped structure, the M magnetic core inductive coils are radially arranged with a geometric center of the rectangular trajectory as the center, and the window plane of the magnetic core inductive coil intersects a plane enclosed by the rectangular trajectory.

17. The method for changing the physicochemical characteristics of the liquid sample according to claim 8, wherein in the induction magnetic field carrier integrated apparatus for inducing the liquid sample to produce the induced electric/magnetic field, the selected trajectory is a linear trajectory, the window plane of the magnetic core inductive coil is parallel to a radial cross section of the hollow structure, and the magnetic core inductive coil set has a columnar structure; and
preferably, the selected trajectory is a straight line trajectory, and a central axis of the hollow structure is parallel to the straight line trajectory.

18. The method for changing the physicochemical characteristics of the liquid sample according to claim 8, wherein in the induction magnetic field carrier integrated apparatus for inducing the liquid sample to produce the induced electric/magnetic field, the sample tube passes through of windows of M magnetic cores in the magnetic core inductive coil set; and/or
a portion of the sample tube located inside the hollow structure is of a columnar structure, a loop-shaped structure, or a spiral structure; and/or
a portion of the sample tube located inside the hollow structure comprises one or more annular tube segments, and the plurality of annular tube segments are formed by winding the sample tube into a planar-spiral or axial-spiral configuration;
preferably, the plurality of annular tube segments are disposed in sequence in an axial direction of a loop-shaped structure/spiral structure formed thereby, or are disposed in sequence in a radial direction of the loop-shaped structure/spiral structure formed thereby; and/or
a portion of the sample tube located inside a hollow region of the magnetic coupling integrated component comprises one or more cylindrical tube segments, and the plurality of cylindrical tube segments are formed by disposing the sample tube in parallel; and/or
the sample tube comprises one or more branch structures, and the branch structure forms a closed loop; and/or
the sample tube is disposed in a sleeve, and the sleeve is disposed in the hollow structure.

19. The method for changing the physicochemical characteristics of the liquid sample according to claim 8, wherein the induction magnetic field carrier integrated apparatus for inducing the liquid sample to produce the induced electric/magnetic field further comprises a cooling module, the cooling module is configured to adjust an operating temperature of the magnetic coupling integrated component.

20. The method for changing the physicochemical characteristics of the liquid sample according to claim 14, wherein in the induction magnetic field carrier integrated apparatus for inducing the liquid sample to produce the induced electric/magnetic field, an effective cross-sectional area of a magnetic circuit of the single magnetic core inductive coil in the magnetic coupling integrated component is 0.8 cm²-200 cm².
